(19) United States
(12) Patent Application Publication
(10) Pub. No.: US 2026/0135125 A1
(43) Pub. Date: May 14, 2026

(54) SEPARATOR FOR FUEL CELL

(71) Applicant: TOYOTA JIDOSHA KABUSHIKI KAISHA, Toyota-shi (JP)

(72) Inventors: Kyosuke HAYASHI, Toyota-shi (JP); Tohru ODA, Toyota-shi (JP); Takami UMEDA, Miyoshi-shi (JP)

(73) Assignee: TOYOTA JIDOSHA KABUSHIKI KAISHA, Toyota-shi (JP)

(21) Appl. No.: 19/259,340

(22) Filed: Jul. 3, 2025

(30) Foreign Application Priority Data
Nov. 13, 2024 (JP) 2024-198033

(51) Int. Cl. H01M 8/026; H01M 8/0206

(52) U.S. Cl. CPC H01M 8/026; H01M 8/0206

(57) ABSTRACT

A separator disclosed in the present specification includes a flat plate substrate of a rectangle, a plurality of gas flow channel grooves provided in the substrate and arranged in parallel, and positioning protrusions provided at at least two locations of four corners of the substrate. Positioning protrusions have a width larger than a width of the gas flow channel groove and a height larger than a depth of the gas flow channel groove. The positioning protrusion has a hollow inside, and the plate thickness is basically the same as the thickness of the substrate. However, in the separator disclosed in the present specification, a thick plate portion having a plate thickness larger than the thickness of the substrate is provided in the positioning protrusion.

### CROSS-REFERENCE TO RELATED APPLICATION

This application claims priority to Japanese Patent Application No. 2024-198033 filed on Nov. 13, 2024. The disclosure of the above-identified application, including the specification, drawings, and claims, is incorporated by reference herein in its entirety.

### BACKGROUND

### 1. Technical Field

The technique disclosed in the present specification relates to a separator for a fuel cell.

### 2. Description of Related Art

In a fuel cell, a separator is disposed between two adjacent membrane electrode assemblies (MEAs). The separator for a fuel cell is often made of a metal plate having a thickness of 1.0 mm or less. The separator is provided with a gas flow channel groove through which oxygen (air) or hydrogen flows. In a manufacturing process of the fuel cell, multiple separators are stacked and prepared. The gas flow channel groove is made by performing press processing on a thin flat plate substrate. The gas flow channel groove has a recessed shape when viewed from one surface of the substrate and has a protruding shape when viewed from an opposite surface thereof. That is, a protruding (recessed) shape having the same size as a recessed (protruding) shape of one surface of the substrate is provided on a back side of the recessed (protruding) shape of the one surface of the substrate. Therefore, in a case where the separators are stacked, an upper protruding (recessed) shape and a protruding (recessed) shape overlap with each other, and air is trapped therebetween, and thus it is difficult to pick up the separators one by one.

Japanese Unexamined Patent Application Publication No. 2007-115600 (JP 2007-115600 A) discloses a technique of sending air into a space between the second separator from the top and the top separator when the top separator is picked up, and making it easier to remove only the top separator.

### SUMMARY

The present specification provides a technique of making it easier to separate a lower separator when the top separator is picked up from a plurality of stacked separators by devising a shape of the separator.

A separator disclosed in the present specification includes:
a substrate that is a rectangular flat plate;
multiple gas flow channel grooves provided in the substrate and arranged in parallel; and
positioning protrusions provided at two or more of the four corners of the substrate.
   Each of the positioning protrusions has the width larger than the width of the gas flow channel groove and the height larger than the depth of the gas flow channel groove.
   The gas flow channel grooves and the positioning protrusions are made by performing press processing on the substrate.
   Therefore, the positioning protrusion is hollow, and the plate thickness thereof is basically the same as the thickness of the substrate.
   Meanwhile, in the separator disclosed in the present specification, the positioning protrusion is provided with a thick plate portion having the plate thickness larger than the thickness of the substrate.

In a case where the positioning protrusions are not provided, when two separators are stacked, the i-th gas flow channel groove of one separator and the (i+1)-th gas flow channel groove of the other separator may overlap with each other accidentally. That is, there is a possibility that the two separators are stacked in a misaligned manner. In a case of the two separators having the above-described positioning protrusions, the positioning protrusions start to overlap with each other before the gas flow channel grooves do. The two separators are accurately stacked by the positioning protrusions being overlapped at two or more places on the substrate. The misalignment in which the gas flow channel grooves at different positions in the upper and lower separators overlap with each other is inhibited. In addition, the positioning protrusions of the two separators stacked in an up-down direction reliably overlap with each other, so that the thick plate portions of the two separators also overlap with each other. The thick plate portions overlap with each other, so that a gap is ensured between the two separators. The possibility of the lower separator remaining stacked when the upper separator is picked up is reduced. In addition, the positioning protrusions are provided at the corners of the substrate, and when the upper separator is lifted, the upper separator starts to be separated from the lower separator at the corners provided with the positioning protrusions. Air enters from the corners where the upper and lower separators start to be separated from each other to the inside, and the upper separator is more easily separated from the lower separator. By adopting the technique disclosed in the present specification, the lower separator is easily separated when the top separator is picked up from the stacked separators.

Details of the technique and further improvements disclosed in the present specification will be described in “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a separator of an embodiment;

FIG. 2 is a cross-sectional view of a separator taken along a line II-II of FIG. 1;

FIG. 3A is a cross-sectional view of two overlapped separators (embodiment);

FIG. 3B is a cross-sectional view of two overlapped separators (conventional example);

FIG. 4 is a cross-sectional view showing a state in which the separator is lifted from the end; and

FIG. 5 is a cross-sectional view of two overlapping separators (modification).

### DETAILED DESCRIPTION OF EMBODIMENTS

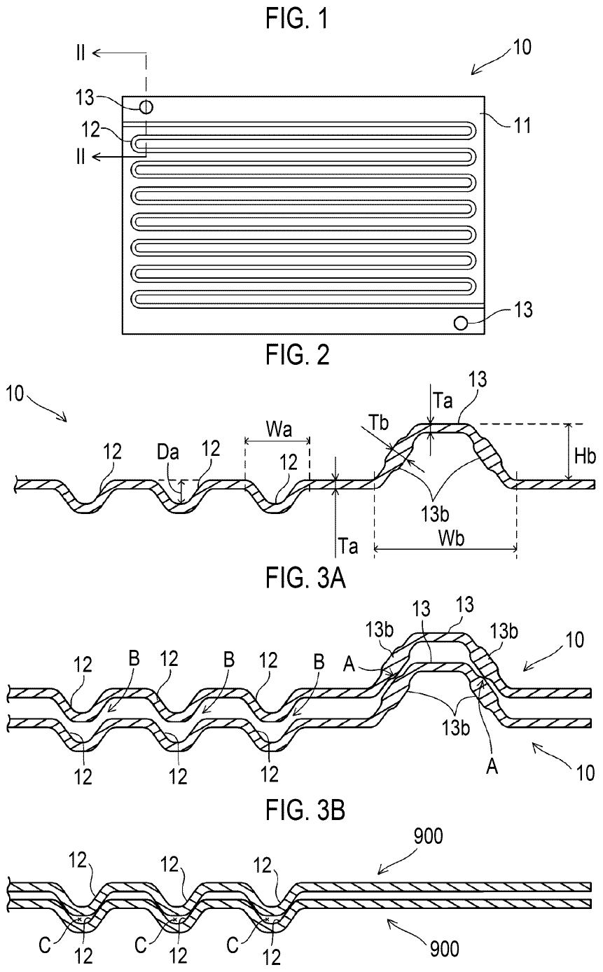

A separator 10 of an embodiment will be described with reference to the drawings. The separator 10 is a component disposed between two adjacent membrane electrode assemblies (MEAs) in the fuel cell. FIG. 1 is a plan view of a separator 10, and FIG. 2 is a cross-sectional view of the separator 10 taken along a line II-II of FIG. 1.

The separator 10 is a thin metal plate provided with the gas flow channel groove 12 and the positioning protrusion 13. A metal plate that is a base material of the separator 10 is referred to as a substrate 11 in the present specification. The gas flow channel groove 12 and the positioning protrusion 13 are made by press processing. Therefore, the gas flow channel groove 12 has a recessed shape on one surface of the substrate 11 and has a protruding shape on the opposite surface. On the other hand, the positioning protrusion 13 has a protruding shape on one surface of the substrate 11 and has a recessed shape on the opposite surface. Therefore, the gas flow channel groove 12 is a hollow shaped in a plate having a plate thickness Ta of the substrate 11, and the positioning protrusion 13 has a dome shape constructed using the plate thickness Ta. However, the positioning protrusion 13 includes a thick plate portion 13b having a plate thickness Tb larger than a plate thickness Ta of the substrate (see FIG. 2).

The thick plate portion can be molded by devising a mold for press processing. Specifically, two protrusions adjacent to each other are provided in a mold that sandwiches the substrate, and a hollow is provided between the adjacent protrusions. When the mold is closed with the substrate interposed therebetween, the plate thickness of the portion sandwiched by the protrusions is reduced, the metal extruded into the protrusions is gathered in the hollow, and the thick plate portion is provided.

Although the gas flow channel groove 12 is one in an entirety of the substrate 11, it appears as a plurality of grooves arranged in parallel when viewed locally. For example, in FIG. 1, the II-II line crosses three parallel gas flow channel grooves 12. As described above, the gas flow channel groove 12 need only be seen as a plurality of grooves parallel to each other when the substrate 11 is seen locally. Although the gas flow channel grooves 12 are provided on each of both surfaces of the substrate 11, in the drawing, the gas flow channel grooves on the other surface are not shown. In the fuel cell stack, oxygen flows through the gas flow channel grooves on one surface of the separator 10, and hydrogen flows through the gas flow channel grooves on the other surface.

The substrate 11 is rectangular in plan view, and the positioning protrusions 13 are provided at two diagonally opposite corners of the rectangular substrate 11.

As shown in FIG. 2, the height Hb of the positioning protrusion 13 is greater than the groove depth Da of the gas flow channel groove 12. In addition, the width Wb of the positioning protrusion 13 is larger than the groove width Wa of the gas flow channel groove 12. In one example, the groove width Wa of the gas flow channel groove 12 is about 1 [mm], and the width Wb of the positioning protrusion 13 is about 5 [mm]. In one example, the groove depth Da of the gas flow channel groove 12 is about 1 [mm], and the height Hb of the positioning protrusion 13 is about 5 [mm].

The positioning protrusion 13 has the following advantages. When the two separators 10 are stacked, the positioning protrusions 13 of the upper and lower separators 10 respectively accurately position the upper and lower separators 10 with respect to each other. A height Hb of the positioning protrusion 13 is greater than a groove depth Da of the gas flow channel groove 12. Therefore, when the two separators 10 are stacked, the positioning protrusions 13 contact each other before the gas flow channel grooves 12 contact each other. The two separators 10 are aligned with each other by overlapping the positioning protrusion 13 of one separator 10 with the positioning protrusion 13 of the other separator 10. Since each of the separators 10 includes the positioning protrusions 13 at at least two places, the two separators 10 are accurately positioned and overlap each other. In a case where the positioning protrusion 13 is not provided, the following disadvantages may occur. A plurality of gas flow channel grooves 12 arranged in parallel is provided in the substrate 11. In a case where the separators 10 do not have the positioning protrusions, the i-th gas flow channel groove of one separator 10 and the (i+1)th (or (i−1)th) gas flow channel groove of the other separator 10 may overlap. That is, there is a possibility that the two separators 10 are misaligned and overlapped. The positioning protrusion 13 can prevent such a positional misalignment.

In addition, the positioning protrusion 13 has an advantage that the lower separator 10 is easily separated from the upper separator 10 when the top separator 10 of the overlapped separators 10 is picked up. FIG. 3A is a cross-sectional view of the two separators 10 in a state of being overlapped. FIG. 3B is a cross-sectional view in which the conventional separator (the separator 900 having no positioning protrusion) is overlapped. In a case where the separators 900 do not have the positioning protrusions, the gas flow channel grooves 12 of the upper separator 900 and the gas flow channel grooves 12 of the lower separator 900 are in contact with each other. Then, a sealed space C sandwiched between the upper and lower gas flow channel grooves 12 is generated (see FIG. 3B). The air in the sealed space C is difficult to leave the separators 900 above and below.

On the other hand, in the separator 10 of the embodiment, the positioning protrusions 13 of the upper and lower separators 10 overlap each other, so that the thick plate portion 13b of the upper separator 10 also overlaps the thick plate portion 13b of the lower separator 10 (the portion indicated by the arrow A in FIG. 3A). The thick plate portions 13b of the upper and lower separators 10 overlap each other, so that a gap is secured between the gas flow channel grooves 12 of the upper and lower separators 10 (a portion indicated by an arrow B in FIG. 3A). Since the gas flow channel grooves 12 of the upper and lower separators 10 do not come into contact with each other, the sealed space C shown in FIG. 3B is not provided. Therefore, when the upper separator 10 is picked up, the lower separator 10 is easily separated.

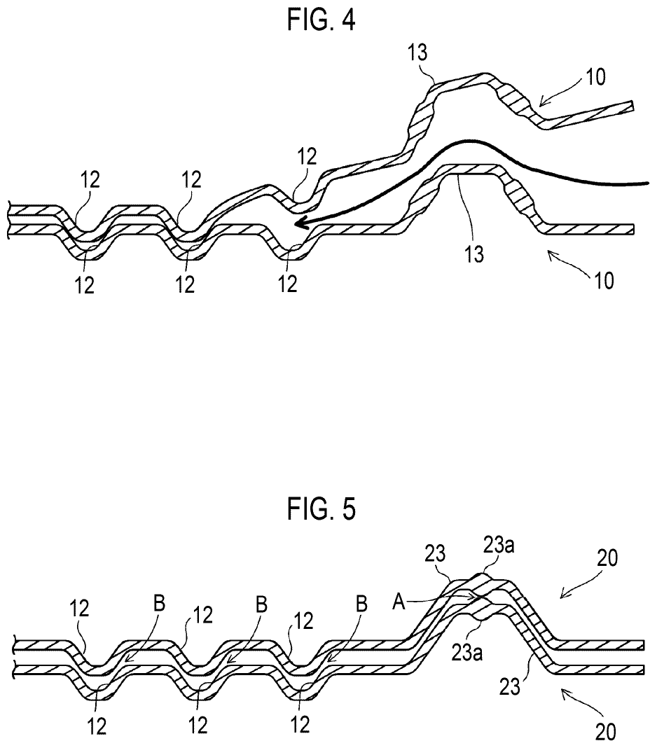

Further, the positioning protrusion 13 is provided at a corner of the substrate 11. Since the substrate 11 of the separator 10 is a thin metal plate, the substrate 11 is easily bent. As shown in FIG. 4, when the end of the substrate 11 of the upper separator 10 is lifted, first, the positioning protrusion 13 of the upper separator 10 is separated from the lower separator 10. Air enters between the positioning protrusions 13 of the upper and lower separators 10, and it is easier for air to enter between the upper and lower gas flow channel grooves 12. As a result, the lower separator 10 is more easily separated from the upper separator 10 when the upper separator 10 is picked up. A thick arrow line in FIG. 4 schematically represents the flow of air.

As described above, the positioning protrusion 13 having the thick plate portion 13b can align the accurate positions of the separators 10 with each other when the separators 10 are stacked up and can easily separate the lower separator 10 from the upper separator 10 when the upper separator 10 is picked up.

FIG. 5 is a cross-sectional view of the separator 20 of the modification. The positioning protrusion 23 is different from the separator 10 of the embodiment in that the positioning protrusion 23 has a thick plate portion 23b at the top. Even when the thick plate portion 23b is provided at the top of the positioning protrusion 23, the gap B is secured between the gas flow channel grooves 12 of the upper and lower separators 10. A reference numeral A of FIG. 5 indicates a place where the thick plate portions 23b of the upper and lower separators 20 are in contact with each other.

In the separator 10 of the embodiment (see FIG. 2), a plurality of thick plate portions 13b may be provided on one positioning protrusion 13, or one thick plate portion 13b of the protrusion may be provided to surround the inclined surface of the positioning protrusion 13. In the separator 20 of the modification, the size of the thick plate portion 23b can be made smaller than the size of the thick plate portion 13b of the separator 10 of the embodiment by providing the thick plate portion 23b at the top of the positioning protrusion 23.

Points to consider regarding the technique described in the embodiment will be described. In the separator 10 of the embodiment, the positioning protrusion 13 is circular when the substrate 11 is viewed in plan. The positioning protrusion may be an elongated protruding column. At least two positioning protrusions may be provided on one separator. Each positioning protrusion may be provided at any of the four corners of the rectangular separator. The positioning protrusion may be provided on either of both surfaces of the separator.

Although specific examples of the aspect of the disclosure have been described above in detail, the examples are merely illustrative and are not intended to limit the scope of the claims. The technology described in the claims includes various modifications and changes of the specific examples exemplified above. The technical elements described in the present specification or the drawings exhibit technical usefulness alone or in various combinations, and are not limited to the combinations described in the claims at the time of filing. Further, the technology exemplified in the present specification or the drawings can achieve a plurality of objectives at the same time, and achieving one of the objectives has technical usefulness.

What is claimed is:

1. A separator for a fuel cell, the separator comprising:
a substrate that is a rectangular flat plate;
multiple gas flow channel grooves provided in the substrate and arranged in parallel; and
positioning protrusions provided at two or more of four corners of the substrate, each of the positioning protrusions having a width larger than a width of the gas flow channel groove and a height larger than a depth of the gas flow channel groove,
wherein the positioning protrusion is hollow and is provided with a thick plate portion having a plate thickness larger than a thickness of the substrate.
